(19) United States
(12) Patent Application Publication
(10) Pub. No.: US 2008/0209544 A1
(43) Pub. Date: Aug. 28, 2008

(54) Device security method using device specific authentication

(75) Inventor: Anthony A. Kempka, Backus, MN (US)

Correspondence Address: Douglas E. McKinley, Jr., P.O. Box 202, Richland, WA, 99352, US

(73) Assignee: Battelle Memorial Institute

(21) Appl. No.: 11/711,956

(22) Filed: Feb. 27, 2007

(51) Int. Cl. H04L 9/32

(52) U.S. Cl. 726/17

(57) ABSTRACT

A method for improving security to a computer system, and a computer system with improved security, that performs the steps of interrogating at least one device in communication with the computer system to gather a device identifier uniquely identifying the device, compares the device identifier with a list of identifiers to determine a level of trust, and regulates communication between the device and the computer based upon the level of trust.

The invention was made with Government support under Contract DE-AC0676RLO 1830, awarded by the U.S. Department of Energy. The Government has certain rights in the invention.

### TECHNICAL FIELD

This invention relates to methods for improving the security of computer systems. More specifically, this invention relates to methods for improving the security of computer systems with respect to threats such as malware and spyware that may be present in storage devices connected to computer systems.

### BACKGROUND OF THE INVENTION

Computer systems are commonly connected to devices, including but not limited to peripheral storage devices such as CD/DVD drives, USB thumb drives, hard disk drives, and the like. Currently, these devices are typically not identified, verified, authenticated, or secured by the computer system. More typically, when storage devices are connected to the computer system, they become available for use immediately. As a result, software code that may be present on these storage devices may gain access to the computer system. Software code given access to a computer system in this manner may then be operated in a manner that would harm the computer system. Alternatively, the computer system may contain information or data which the user desires to protect from unauthorized dissemination. In such a circumstance, it may be desirable to have security in place that prevents the transfer of information or data from the computer system to devices which have not been authorized to receive such information or data. Accordingly, there exists a need for new methods and techniques that protect computer systems from malicious software that may be present on peripheral storage devices, and provide computer users with the ability to prevent the unauthorized transfer of information and data from protected computer systems to peripheral storage devices. The present invention addresses that need.

### SUMMARY OF THE INVENTION

One object of this invention is to provide a method for improving security to a computer system. As an apparatus, the present invention is provided in the form of a computer system that can perform the method of the present invention, or a computer readable medium that can be used to configure a computer system to perform the method of the present invention. Whether provided as a method, a computer system, or a computer readable medium that may be used to configure a computer system, a computer system utilizing the present invention performs the steps of interrogating at least one device in communication with the computer system to gather a device identifier that uniquely identifies the device. As used herein, a “device” would include, but is not limited to, compact discs, digital versatile discs, compact disc drives, digital versatile disc drives, hard drives, thumb drives, PCI cards, printers, scanners, magneto optical drives, magneto optical storage media, and compact flash drives.

A “device identifier” as the term is used herein is information uniquely identifying a particular hardware component or storage media that may be attached to a computer. Often, manufacturers provide hardware components with information that may be used to generate all or part of the device identifiers. Typical information that may be used to form device identifiers thus includes, but is not limited to, the manufacturer's name, the model name and/or serial number, and the component serial number. Information provided with the device by the manufacturer may be augmented or supplanted with information written to the device by the present invention. Thus, the term “device identifier” thus may include exclusively information written to the device by the present invention, exclusively information provided by the device itself, and/or some combination of information written to the device by the present invention and information provided by the device itself. The method of the present invention thus may have the additional step of writing at least a portion of at least one device identifier to a device.

Whatever the source, this “device identifier” information may be encrypted using known public and private key techniques. Further, the device identifier may be generated by a hash function applied to any of the forgoing information, in an encrypted or an unencrypted form. Finally, in circumstances where a device is used in conjunction with a removable storage media, for example, and not meant to be limiting, a CD RW drive and a CD, or a floppy disc and a floppy disc drive, both the drive and the individual storage media used in those drives may be associated with separate and unique device identifiers. Thus, each CD or a floppy disk would be associated with a unique device identifier, and each drive used to play the CD or the floppy disk would be associated with unique device identifier. Thus, as used herein, the term “device identifier” should be understood to encompass all of these possibilities.

Interrogating the device in communication with the computer system may happen at start up of the computer system, or when a device is attached to an already running computer system. The device identifier is then compared with a list of identifiers to determine a level of trust. Communication between the device and the computer may then be regulated based upon the level of trust. In this manner, malicious code may be identified without unduly harming system performance.

As used herein, the term “regulating communication” means that digital information is passed between the device and the computer according to rules based upon the level of trust associated with the device. Thus, for example, a particular device may be trusted completely. In this case, the device would interact with the computer with no further interference from the present invention. Alternatively, by way of example and not meant to be limiting, a particular device may not be trusted at all. In this case the present invention would act to insure no communication between the device and the computer is permitted. Between these extremes, the present invention may establish intermediate levels of trust.

Devices identified as having intermediate levels of trust may be permitted to communicate with the computer in some ways but not others. For example, and not meant to be limiting, the present invention may allow information to be retrieved from a device having an intermediate level of trust, but not stored on or written to that device; or conversely, stored on or written to a device having an intermediate level of trust, but not retrieved from that same device.

The step of interrogating the device may be performed at several different times during operation, either alone or in combination, and/or at several different locations within the computer system, also either alone or in combination. Accordingly, all of the following, either alone or in combination, should be understood to be contemplated by the present invention:

Interrogating the device may be performed when the computer system is powered up as part of the power on self test process executed by the BIOS.

Interrogating the device may be performed when the operating system is loaded into memory and started.

Interrogating the device may be performed as a stand alone process independent of the BIOS and the operating system.

Interrogating the device may be performed when a device is connected to a running operating system.

Interrogating the device may be performed prior to instantiation of the device by the operating system.

Interrogating the device may be performed after instantiation of the device by the operating system.

Once the device has been interrogated, and the level of trust has been established, one or more additional security processes may be initiated if a device fails to achieve a threshold level of trust.

As used herein the present invention determines the “level of trust” associated with a particular device based upon whether the system recognizes the device identifier, the type of device and, in some cases, a specific assignment made to a specific device by a user or a system administrator. In most cases, a recognized device will be given the highest level of trust, which will allow the computer to interact with the device with no further interference with the present invention. In some cases, even though a device has been recognized by its device identifier, the computer may be given less than the highest level of trust. For example, and not meant to be limiting, a USB thumb drive or a CD RW may be recognized by its device identifier. The computer may nevertheless not be given permission to write information to the device, but will be given permission to retrieve information from the device. Also, a user or system administrator may specifically designate a level of trust for a specific device. For example, a system administrator may connect a USB thumb drive to many different computer systems. Thus, when connecting this particular device to the system administrator's computer system, the system administrator may wish to have the present invention assign this USB thumb drive a low level of trust, even though the system administrator's computer system will recognize the device identifier for the USB thumb drive. Accordingly, as used herein the “level of trust” between a computer and a device should be understood to mean the amount of interaction permitted by the present invention between a computer and a device attached to that computer. The level of trust will be determined by whether the system recognizes the device identifier for the device, and the type of device, and the potential for devices of a particular type for harming the computer or providing a pathway for unauthorized releases of information from the computer.

### BRIEF DESCRIPTION OF THE DRAWINGS

The following detailed description of the embodiments of the invention will be more readily understood when taken in conjunction with the following drawing, wherein:

FIG. 1 is a flow chart showing how a computer system configured with a preferred embodiment of the present invention may access devices.

FIG. 2 is a flow chart showing how a computer system configured with a preferred embodiment of the present invention may encounter new devices.

### DETAILED DESCRIPTION OF THE PREFERRED EMBODIMENTS

For the purposes of promoting an understanding of the principles of the invention, reference will now be made to the embodiments illustrated in the drawings. Specific language will be used to describe the same. It will nevertheless be understood that no limitations of the inventive scope is thereby intended, as the scope of this invention should be evaluated with reference to the claims appended hereto. Alterations and further modifications in the illustrated devices, and such further applications of the principles of the invention as illustrated herein are contemplated as would normally occur to one skilled in the art to which the invention relates.

The major data structures for the preferred embodiment of the present invention are provided in table 1.

TABLE 1
Major Data Structures

| Element name | Description |
|---|---|
| Hash algorithm | (e.g., SHA-1, SHA-256, etc.) |
| Hash input | Numeric sources for hash function: |
| | 1 - Device S/N |
| | 2 - Computer GUID |
| | 4 - User ID |
| | 8 - Bus address |
| | 16 - Info stored on device |
| | Etc. |
| | Bit flags used alone or in combination |
| Hash value | Computed from device information (e.g., S/N), |
| | optional information stored on devices, unique |
| | computer identifier (GUID), user identifier, etc. |
| Device type | Hard disk, USB thumb drive, CDROM, floppy |
| | drive, USB 2.0 external disk, network adapter, |
| | etc. |
| OS specific | (e.g., device file handle, etc.) |
| information | |
| Level of trust | Example levels (bit flags): |
| | 0 - no access allowed |
| | 1 - read access allowed |
| | 2 - write access allowed |
| | 3 - configuration access allowed |
| | Etc. |
| | Flags used alone or in combination. |
| Additional security | 0 - no processing needed |
| processing needed | 1 - additional processing needed |
| Additional security | Program, process or subroutine that is |
| processing ID | required for additional security processing of |
| | device |
| Additional security | 0 - processing failed (access not allowed) |
| processing result | 1 - processing succeeded (access allowed) |
| Date device | First date the device was encountered |
| first encountered | |
| Date device | Last date the device was used |
| last encountered | |

As shown in table 1, several data structures are built and utilized by the present invention. The Hash input is the “device identifier” and thus may include information written to the device by the present invention, information provided by the device itself, and/or some combination of information written to the device and information provided by the device itself. The Hash value is generated by applying the Hash algorithm to the Hash input.

The Hash algorithm is preferably selected from the five Federal Information Processing Standards (FIPS) for Secure Hash Algorithm Hash functions (SHA), which are used for computing a condensed digital representation. These condensed digital representations produced by these SHAs, (e.g., SHA-1, SHA-256, etc.), are commonly known as a “message digests” and, to a high degree of probability, are unique for a given input data sequence. Federal Information Processing Standards (FIPS) are publicly announced standards developed by the United States Federal government for use by all non-military government agencies and by government contractors.

The Device type data structure simply refers to all of the possible devices that may be attached to the computer system.

OS specific information simply refers to information that is specific to the operating system environment of the computer system, such as the device file handle.

The level of trust are set by flags, used alone or in combination. For example, in the preferred embodiment of the present invention described herein, the following flags are shown: 0—no access allowed, 1—read access allowed, 2—write access allowed, 3—configuration access allowed. Based on the level of trust, it can then be determined if additional security processing needed. Two flags are possible, 0—no processing needed and 1—additional processing needed. If additional processing is needed, the additional security processing ID is invoked. This is simply a program, process or subroutine that is required for additional security processing of device. The additional security processing result is then flagged. As shown in table 1, two flags are possible, 0—processing failed (access not allowed) and 1—processing succeeded (access allowed). Finally, the date the device was first encountered, and the date the device was last encountered are both detected and flagged.

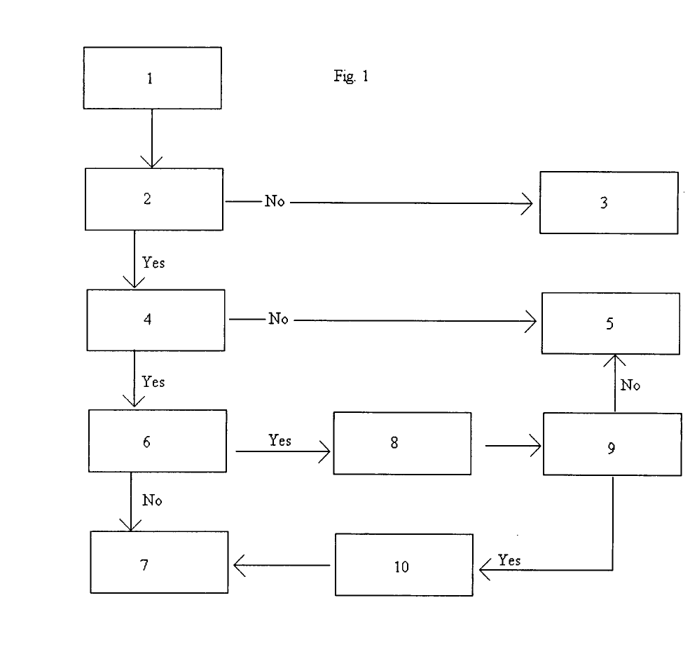

FIG. 1 is a flow chart showing how a computer system configured with a preferred embodiment of the present invention may access devices. As shown in the Figure, for all devices controlled by the operating system and accessed by applications or users, a device access message such as read, write, configure is intercepted, a box 1. At box 2, the method asks if the device on the allowed list? If the device is not on the allowed list, access fails, box 3. If the device is on the allowed list, access proceeds to box 4 which asks: what access type is allowed for this device; eg. read, write, or configuration?, which is in turn determined by the level of trust associated with that device. If the access type is not allowed for that device, access is denied, box 5. If the access type is allowed for that device, processing continues to box 6, which asks is additional security processing needed? Additional processing might include, by way of example and not limitation, a scan for viruses. If no additional security processing is needed, access is allowed, box 7. If additional processing is needed, it is performed at box 8, and the process continues to box 9, which determines whether the additional scanning was successful; eg. was a detected virus removed? If additional scanning was successful, access is allowed, box 7. If additional scanning was not successful, access for the device is denied, box 5.

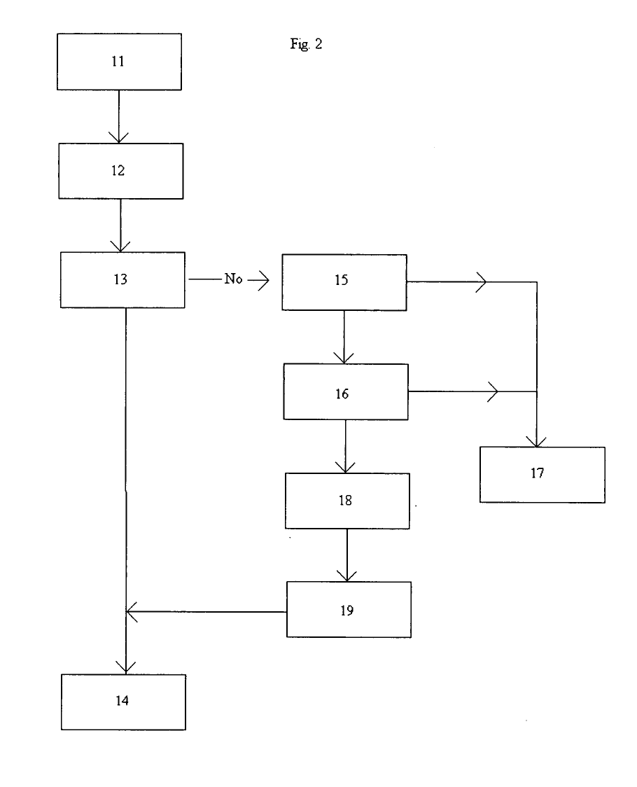

FIG. 2 is a flow chart showing how a computer system configured with a preferred embodiment of the present invention may access new devices as they are first encountered. Devices may be accessed either at startup or as an operating system detects devices as they arrive during operation (eg. hot plug or PnP). Either way, a new device is enumerated 11 when it is detected. The system then obtains 12 the unique device identifier associated with the new device, as described above. The unique device identifier is then compared 13 with a list of allowed device identifiers. If the device identifier is found in the list of allowed devices, the new device is enabled 14. If the device identifier is not found in the list of allowed devices, the system is queried to determine if new devices are allowed 15. If no new devices are allowed, the new device is rejected and disabled 17. If new devices are allowed, the system then determines if the new device is one of the types of devices that are allowed 16. If new devices are allowed, but the system determines that the new device is not one of the types of devices that are allowed 16, the new device is rejected and disabled 17. If new devices are allowed, and the system determines that the new device is one of the types of devices that are allowed 16, the new device's device identifier is added to the list of allowed device identifiers 18, the new device is assigned a level of trust 19, the new device is enabled 14.

While the invention has been illustrated and described in detail in the drawings and foregoing description, the same is to be considered as illustrative and not restrictive in character. Only certain embodiments have been shown and described, and all changes, equivalents, and modifications that come within the spirit of the invention described herein are desired to be protected. The preferred embodiments described herein are intended to be illustrative of the present invention and should not be considered limiting or restrictive with regard to the invention scope. Further, any theory, mechanism of operation, proof, or finding stated herein is meant to further enhance understanding of the present invention and is not intended to limit the present invention in any way to such theory, mechanism of operation, proof, or finding.

Thus, the specifics of this description and the attached drawings should not be interpreted to limit the scope of this invention to the specifics thereof. Rather, the scope of this invention should be evaluated with reference to the claims appended hereto. In reading the claims it is intended that when words such as “a”, “an”, “at least one”, and “at least a portion” are used there is no intention to limit the claims to only one item unless specifically stated to the contrary in the claims. Further, when the language “at least a portion” and/or “a portion” is used, the claims may include a portion and/or the entire items unless specifically stated to the contrary. Finally, all publications, patents, and patent applications cited in this specification are herein incorporated by reference to the extent not inconsistent with the present disclosure as if each were specifically and individually indicated to be incorporated by reference and set forth in its entirety herein.

The invention claimed is:

1) A method for improving security to a computer system comprising the steps of:
a. interrogating at least one device in communication with the computer system to gather a device identifier uniquely identifying said device,
b. comparing said device identifier with a list of identifiers to determine a level of trust,
c. regulating communication between the device and the computer based upon the level of trust.

2) The method of claim 1 wherein the step of interrogating at least one device is performed when the computer system is powered up as part of the power on self test process executed by the BIOS.

3) The method of claim 1 wherein the step of interrogating at least one device is performed when the operating system is loaded into memory and started.

4) The method of claim 1 wherein the step of interrogating at least one device is performed as a stand alone process independent of the BIOS and the operating system.

5) The method of claim 1 wherein the step of interrogating at least one device is performed when a device is connected to a running operating system.

6) The method of claim 5 wherein the step of interrogating at least one device is performed prior to instantiation of the device by the operating system.

7) The method of claim 5 wherein the step of interrogating at least one device is performed after instantiation of the device by the operating system.

8) The method of claim 1 wherein at least one additional security process is initiated if a device fails to achieve a threshold level of trust.

9) The method of claim 1 having the additional step of writing at least a portion of at least one device identifier to a device.

10) The method of claim 1 wherein the device is selected from the group consisting of compact discs, digital versatile discs, compact disc drives, digital versatile disc drives, hard drives, thumb drives, PCI cards, printers, scanners, magneto optical drives, magneto optical storage media, compact flash drives, and combinations thereof.

11) A computer system having improved security configured to perform the steps comprising:
a. interrogating at least one device in communication with the computer system to gather a device identifier uniquely identifying said device,
b. comparing said device identifier with a list of identifiers to determine a level of trust,
c. regulating communication between the device and the computer based upon the level of trust.

12) The computer system having improved security of claim 11 wherein the step of interrogating at least one device is performed when the computer system is powered up as part of the power on self test process executed by the BIOS.

13) The computer system having improved security of claim 11 wherein the step of interrogating at least one device is performed when the operating system is loaded into memory and started.

14) The computer system having improved security of claim 11 wherein the step of interrogating at least one device is performed as a stand alone process independent of the BIOS and the operating system.

15) The computer system having improved security of claim 11 wherein the step of interrogating at least one device is performed when a device is connected to a running operating system.

16) The computer system having improved security of claim 15 wherein the step of interrogating at least one device is performed prior to instantiation of the device by the operating system.

17) The computer system having improved security of claim 15 wherein the step of interrogating at least one device is performed after instantiation of the device by the operating system.

18) The computer system having improved security of claim 11 wherein at least one additional security process is initiated if a device fails to achieve a threshold level of trust.

19) The computer system having improved security of claim 11 having the additional step of writing at least a portion of at least one device identifier to a device.

20) The computer system having improved security of claim 11 wherein the device is selected from the group consisting of compact discs, digital versatile discs, compact disc drives, digital versatile disc drives, hard drives, thumb drives, PCI cards, printers, scanners, magneto optical drives, magneto optical storage media, compact flash drives, and combinations thereof.
